(19) United States
(12) Patent Application Publication
(10) Pub. No.: US 2005/0249948 A1
(43) Pub. Date: Nov. 10, 2005

(54) Oriented strand boards comprising specialty paper

(76) Inventor: Yvon Lavoie, Montreal (CA)

Correspondence Address: MEREK, BLACKMON & VOORHEES, LLC, 673 S. WASHINGTON ST., ALEXANDRIA, WV, 22314, US

(21) Appl. No.: 11/113,305

(22) Filed: Apr. 25, 2005

(30) Foreign Application Priority Data
Apr. 23, 2004 (CA) 2,465,148

(51) Int. Cl. B32B 19/00

(52) U.S. Cl. 428/357

(57) ABSTRACT

An oriented strand board (OSB) comprising one or more specialty paper types. These one ore more specialty paper types demonstrate one or more particular physical, mechanical and/or chemical properties. The foregoing properties of these one or more specialty papers are conferred to the OSB.

### CROSS REFERENCE TO RELATED APPLICATIONS

This application claims priority on Canadian Application No. 2,465,148 filed on 23 Apr. 2004.

### FIELD OF THE INVENTION

The present invention relates to oriented strand boards (OSB). More specifically, the present invention is concerned with an OSB that includes specialty paper strands.

### BACKGROUND OF THE INVENTION

Oriented Strand Boards or OSBs are well known in the art. A unique feature of OSB that long wood strands are oriented, not randomly placed. In North America, the OSB has virtually replaced other panels in new residential construction. All model-building codes in the U.S. and Canada recognize OSB panels for the same uses as plywood on a thickness-by-thickness basis.

Oriented Strand Board (OSB) is an engineered, mat-formed panel product made of strands, flakes or wafers sliced from small diameter, round wood logs and bonded with an exterior-type binder under heat and pressure.

FIG. 1 shows a prior art OSB structure as it is produced across the industry. The OSB consists of layered mats (Layers 1, 2, 3, and 4). Exterior or face layers 1 and 4 are composed of strands aligned in the long panel direction; these strands represent about 55% of the mat. Inner-layers 2 and 3 consist of cross- or randomly-aligned strands; these strands represent about 45% of the mat. These large mats are then subjected to intense heat and pressure to become a “master” panel and are cut to size. The thickness of each layer (t1, t2, t3, t4) depends on specific board thickness.

It should be noted that wafers in core layers could also be randomly distributed. The mechanical and chemical resistances depend on wood species.

Strand dimensions are predetermined and have a uniform thickness. The majority of structural board mills use a combination of strands up to 6″ (150 mm) long and 2″ (25 mm) wide.

OSB's strength is mainly provided from the uninterrupted wood fiber, interweaving of the long strands or wafers, and degree of orientation of strands in the surface layers. Waterproof and boil proof resin binders are combined with the strands to provide internal strength, rigidity and moisture resistance.

OSB, as a performance-based structural use panel, is recognized by all major U.S. model code agencies through the adoption of DOC PS2-92 Wood-Based Structural Use Panels. Certified to CSA 0325 and CSA 0437, OSB is accepted in the National Building Code of Canada, certified to EN 300 and recognized for structural use in Europe and certified to meet the JAS standard for structural panels in Japan. Members of the Structural Board Association are specialists in OSB and are committed to “Total Quality” manufacture of OSB and waferboard for use in North America and overseas.

There are many steps in the manufacturing process of an OSB. The following is a brief description of these steps:
Log sorting: After harvest, whole aspen (or south yellow pine) logs are hauled to the mill's wood yard, and then sorted.
Jackladder: Logs are soaked to remove ice and prepare wood for stranding then sent up the jackladder.
Debarking: Logs are run through the debarker to remove bark. Bark is later used as fuel in the mill's energy supply.
Stranding: The strands are cut from whole logs into precise dimensions of up to six inches long.
Wet bins: Strands are deposited into wet bins.
Drying: Strands are then dry until the appropriate moisture content is reached.
Dry bins: Strands are deposited into dry bins.
Blending: Where strands are blended with resin binders (such as phenol-formaldehyde (PF) resin or poly-isocyanate resin often called PMDI) and a small amount of wax, which improves the efficiency of the resin binder and enhances the panel's resistance to moisture and water absorption.
Forming line: Strands go through the forming line where cross-directional layers are formed.
Pressing: Where layers of strand are pressed under intense heat and pressure to form a rigid, dense structural panel of oriented strands or OSB. In the case of a multi-opening press, there are three steps. The first step in press cycle consists of closing the press platens to the desired target board thickness; the final position of the platens (nominal board thickness) must not be reached before the core temperature is at a minimum temperature which is about 70° C.-80° C. This is to insure wood plasticity necessary for compression. The first step represents about 26% of total press cycle for a 7/16″ board. The second step consists in maintaining the mat of wafers between the two platens for a given period of time until the resin is essentially set. The temperature of the platens is normally greater than the minimum temperature needed to activate and cure the resin (around 200° C.). The second step represents about 50% of the total press cycle. The third and last step consists in releasing the pressure inside the mat (about 24% of total press cycle). This is done by slightly opening the platens for a short period of time and then by completely opening the press and ejecting the essentially completed board.
Finishing line: Panels are cooled, cut to size, grade stamped, stacked in bundles and edge coated. All graded panels bear a mandatory certification agency stamp, plus the SBA logo if applicable.
Shipping: Finally, the panels are ready to be loaded and shipped to destinations around the world. Panels can be ordered smooth sanded for special uses or with tongue and groove edges.

It is understood that the resulting is made of untreated wood strands (raw material e.g. wood strand cut from logs). Moreover, depending of the geographical location of the mill, boards are made from unique wood species, which are available close to the mill such as aspen for the northern mills (mostly in Canada) and south yellow pine for the southern mills (US south) to give but two examples.

Board properties such as density, mechanical resistance (MOE, MOR etc.), resistance to chemicals, swelling, internal bond (IB), as well as other properties are dependent on wood species.

In the manufacturing process of an OSB, there are limited and costly ways to improve board properties, such as adding more resin (glue); increasing press cycle time; increasing temperature of the platen press, among others.

There thus remains a need for an improved OSB.

### OBJECTS OF THE INVENTION

An object of the present invention is to provide an improved oriented strand board.

### SUMMARY OF THE INVENTION

More specifically in accordance with the present invention, there is provided an oriented strand board (OSB) comprising specialty paper, wherein the specialty paper confers its particular physical and/or chemical properties to the OSB.

In accordance with another aspect of the present invention, there is provided an oriented strand board (OSB) comprising wood and specialty paper, wherein the specialty paper confers its particular physical, mechanical and/or chemical properties to the OSB.

In accordance with a further aspect of the present invention, there is provided a method of selectively improving, enhancing and/or modulating one or more particular physical, mechanical and/or chemical properties of an oriented strand board (OSB), the method comprising:

adding one or more types of specialty paper demonstrating one or more particular physical, mechanical and/or chemical properties to the OSB during manufacture thereof so as to confer to the OSB this one or more physical, mechanical and/or chemical properties.

In accordance with yet another aspect of the present invention, there is provided a method of selectively improving, enhancing and/or modulating one or more particular physical, mechanical and/or chemical properties of an oriented strand board (OSB), the method comprising:

identifying one or more specialty papers demonstrating this one or more particular physical, mechanical and/or chemical properties; and

adding this identified one or more specialty papers to the OSB during manufacture thereof.

In accordance with yet a further aspect of the present invention, there is provided a method of selectively improving, enhancing and/or modulating one or more particular physical, mechanical and/or chemical properties of an oriented strand board (OSB), the method comprising:

manufacturing a specialty paper demonstrating one or more desired particular physical, mechanical and/or chemical properties; and

adding this manufactured one or more specialty papers to the OSB during manufacture thereof.

The term “specialty paper” should be construed herein to include without limitation: paper that is often suitable for special purposes, because it possesses unique characteristics and properties, and is not considered to be one of the standards by the paper industry; coated and uncoated paper designed and produced to meet the unique packaging, printing and labeling needs of customers with diverse and specialized paper needs (non-limiting examples include household papers, sanitary papers, base paper of wallpapers, wall paper, decorated sheathing paper, decorating paper, decorative paper, hanging paper, labels, sack papers, wrapping papers, envelopes, packaging, flexible packaging and industrial papers); paper that is not commonly used in the Printing and Publishing shops; an asbestos-containing product that is made of paper intended for use as filters for beverages or other fluids or as paper fill for cooling towers (cooling tower fill consists of asbestos paper that is used as a cooling agent for liquids from industrial processes and air conditioning systems); paper that correspondence to specific criteria such as for example, resistance to grease, or that has a dull finish (i.e. low in gloss) or a glossy finish or any other type. The term “specialty paper” as well the production thereof and specific modification thereof—in order to modulate the particular physical, mechanical and/or chemical properties thereof is well understood by the ordinarily skilled artisan and should be construed as such within the context of the present invention.

In accordance with an embodiment of the invention, anon-limiting advantage of the present invention is that it provides an OSB including specialty paper so as for the specialty paper to confer its properties to the OSB.

Other objects, advantages and features of the present invention will become more apparent upon reading of the following non restrictive description of embodiments thereof, given by way of example only with reference to the accompanying drawings.

### BRIEF DESCRIPTION OF THE DRAWINGS

In the appended drawings where like elements are referenced by like reference numerals and in which:

FIG. 1 is a schematic exploded view of a prior art OSB structure; and

FIG. 2 is a schematic exploded view of an OSB structure in accordance with an embodiment of the present invention.

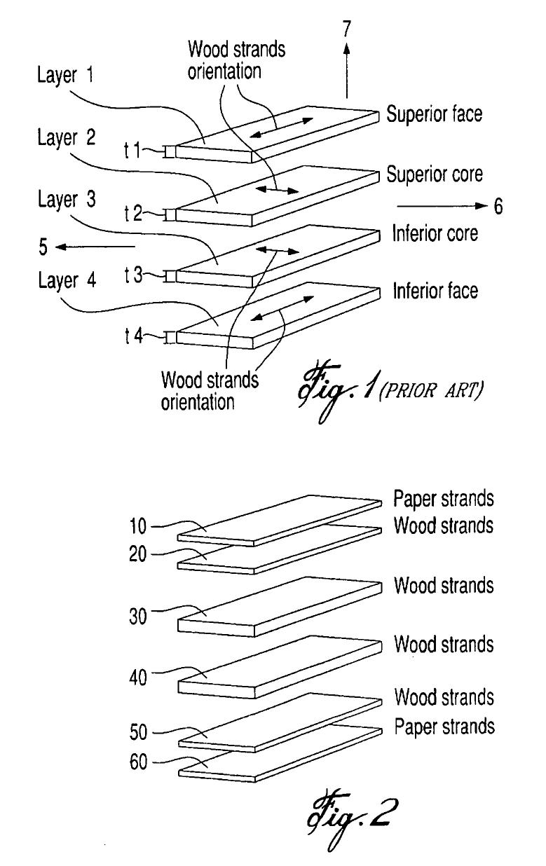

### DESCRIPTION OF THE EMBODIMENT

With reference to the appended drawings an embodiment of the invention will be herein described so as to exemplify the invention and not limit its scope.

There are countless different paper types with specific physical or mechanical and chemical properties that are available to the public.

With reference to FIG. 2, the present invention uses strands made of these specialty papers to manufacture an OSB having improved mechanical and/or chemical properties.

Layers 10 and 20 are made of paper and wood strands respectively and together form a superior face. Layers 30 and 40 form the superior and inferior core of the OSB and are both made of wood strands. Layers 50 and 60 are made of wood and paper strands, respectively, and form the inferior face of the OSB.

In the embodiment illustrated herein, the paper strands are in the exterior faces of the OSB, yet it may be contemplated that specialty paper strands are layers 10, 20, 30, 40, 50 and 60 or any combination thereof.

The number of layers shown in this particular example is six however, yet the number of layers could be varied. When varying the number of layers any layer or layers may be made of this these specialty paper strands.

The thickness of each layer varies accordingly with the specific board property that is sought to be improved. However, the final thickness of the board may remain the same.

In an embodiment, a board is manufactured from special paper strands only.

In another embodiment, the OSB is made of mixed strands having specialty paper impregnated therein. Other materials, such as resins or plastic for example, may also be added to the mixture.

The present invention seeks to use any type of specialty paper in order to confer the physical, mechanical and/or chemical properties of that specialty paper to the OSB that is to be manufactured. If a given specialty paper having a desired physical property is not available, then it is contemplated within the scope of the present invention to first manufacture a type of paper having a particular physical, mechanical and/or chemical property and adding this specialty paper to the OSB that is to be manufactured.

The following are non-limiting examples of three types of specialty paper, including their specifications that are used in the context of the present invention in order to confer their properties to the board manufactured in accordance with the invention:

### EXAMPLE 1

COATED EXTENSIBLE KRAFT (Grade 486)

| | TARGET | MINIMUM | MAXIMUM |
|---|---|---|---|
| BASIS WEIGHT | 50.000 | 47.499 | 52.499 |
| (LB/3000PI²) | | | |
| FORMATION | 1.000 | | |
| MULLEN (PSI) | 50.000 | 45.000 | |
| POROSITY | 35.000 | | |
| (SEC/100 ML) | | | |
| MOISTURE % | 4.500 | 4.000 | |
| TENSILE C.D. | 17.000 | 11.200 | |
| (LBF/INCH) | | | |
| TENSILE TOTAL | 48.000 | 32.200 | |
| (LBF/INCH) | | | |
| TEAR M.D. (GF/16 | 118.000 | 110.000 | |
| PLIES) | | | |
| TOTAL TEAR (GF/16 | 245.000 | 235.000 | |
| PLIES) | | | |
| STRETCH M.D. % | 6.000 | 5.000 | |
| INK TEST (SEC.) | 325.000 | 186.000 | 800.000 |

All tests are done at 50% relative humidity and 23 degrees Celsius.

### EXAMPLE 2

FIRE PROOF ALUMINIUM LAM. PAPER (Grade 5025)

| | TARGET | MINIMUM | MAXIMUM |
|---|---|---|---|
| BASIS WEIGHT | 29.000 | 27.599 | 30.499 |
| (LB/3000PI²) | | | |
| FORMATION | 1.000 | | 5.000 |
| CALIPER (MILS) | 2.700 | 2.100 | 3.000 |
| MULLEN (PSI) | 21.000 | | |
| POROSITY (SEC/100 ML) | 25.000 | 20.000 | |
| MOISTURE % | 3.500 | 3.000 | |
| TENSILE C.D. | 11.000 | | |
| (LBF/INCH) | | | |
| TENSILE M.D. | 22.000 | | |
| (LBF/INCH) | | | |
| TEAR M.D. (GF/16 | 47.000 | | |
| PLIES) | | | |
| TEAR C.D. (GF/16 | 58.000 | | |
| PLIES) | | | |
| COBB 2 MINUTES | .180 | | |
| (G/100 CM²) | | | |
| SMOOTHNESS FELT | 260.000 | | 300.000 |
| (SHEFFIELD) | | | |

All tests are done at 50% relative humidity and 23 degrees Celsius.

### EXAMPLE 3

MULTIWALL BAG (RWS) (Grade 410)

| | TARGET | MINIMUM | MAXIMUM |
|---|---|---|---|
| BASIS WEIGHT | 50.000 | 47.499 | 52.499 |
| (LB/3000PI²) | | | |
| FORMATION | 1.000 | | 5.000 |
| MULLEN (PSI) | 45.000 | 35.000 | |
| WET MULLEN (PSI) | 15.000 | 12.000 | |
| POROSITY (SEC/100 ML) | 20.000 | | |
| MOISTURE % | 7.000 | 4.500 | |
| TENSILE C.D. | 23.000 | 14.700 | |
| (LBF/INCH) | | | |
| TENSILE M.D. | 40.000 | 25.900 | |
| (LBF/INCH) | | | |
| TEAR M.D. (GF/16 | 110.000 | 95.000 | |
| PLIES) | | | |
| TEAR C.D. (GF/16 | 125.000 | 106.000 | |
| PLIES) | | | |
| INK TEST (SEC.) | 335.000 | 186.000 | 800.000 |

All tests are done at 50% relative humidity and 23 degrees Celsius.

Of course, all other specialty papers may be used in the context of the present invention.

During the manufacturing process the following is considered:

The paper is selected in accordance with a particular board property or particular properties that are sought to be improved or modified. In one non-limiting example, using very strong paper strands for the faces produces faces having a greater density as compared to wood strands so that board-bending property (MOE) is significantly improved.

It should be noted that there is no limit regarding the length, width and thickness of the paper strands. Hence, paper strands of various configurations, sizes and materials are used within the context of the present invention.

Furthermore, there is no limit regarding the number of paper strand layers. The number of layers is determined by what degree we want to improve board properties.

By using paper strands, the chemical and mechanical resistance is improved. Moreover, the look of the new board is much better.

The percentage range of the specialty paper with respect to the OSB panel will depend on the effect (i.e. improved or enhanced properties) that is sought.

In one non-limiting example, the ratio of wood that can be used for the superior and inferior faces as well as the core of the OSB can be about 50%.

In another example, if the user seeks to treat the external surfaces of a new OSB so as to improve or enhance certain selected properties than the percentage of paper used can be greater than 0% to about 50% of that external surface. In still another example the external face may be made completely from specialty paper strands.

In an example, if the manufacturer desires to improve the impact resistance of the OSB, extendible paper is added to the core instead of wood strands. This extensible paper can make up between more that 0% to about 50% of the core.

Hence, in accordance with the present invention the specialty paper strands may make up anywhere between more than 0% to 100% of the total material of the OSB panel.

It is to be understood that the invention is not limited in its application to the details of construction and parts illustrated in the accompanying drawings and described hereinabove. The invention is capable of other embodiments and of being practised in various ways. It is also to be understood that the phraseology or terminology used herein is for the purpose of description and not limitation. Hence, although the present invention has been described hereinabove by way of embodiments thereof, it can be modified, without departing from the spirit, scope and nature of the subject invention as defined in the appended claims.

1. An oriented strand board (OSB) comprising specialty paper, wherein said specialty paper confers particular physical, mechanical and/or chemical properties thereof to said OSB.

2. An OSB according to claim 1, wherein said specialty paper comprises a single type of paper.

3. An OSB according to claim 1, wherein said specialty paper comprises a plurality of different types of papers.

4. An OSB according to claim 1, wherein said specialty paper is selected from the group consisting of coated extensible Kraft (grade 486), fireproof aluminium lam paper (grade 5025), multiwall bag (rws) (grade 410) and any combination thereof.

5. An OSB according to claim 1, further comprising two external faces and a core.

6. An OSB according to claim 5, wherein at least one of said two external faces and said core comprise said specialty paper.

7. An OSB according to claim 1 further comprising a plurality of layers, wherein at least one said layer comprises said specialty paper.

8. An OSB according to claim 1, wherein said specialty paper comprises more than 0% to less than 100% of the total material of said OSB.

9. An OSB according to claim 1, further comprising wood.

10. An OSB according to claim 9, further comprising another material.

11. An OSB according to anyone of claims 10, wherein said another material is selected from the group consisting of resin, plastic, metal, a synthetic material or any combination thereof.

12. An OSB according to claim 10, wherein said another material is impregnated in said wood and/or said specialty paper.

13. An OSB according to claim 1, further comprising another material.

14. An OSB according to anyone of claims 13, wherein said another material is selected from the group consisting of resin, plastic, metal, a synthetic material and any combination thereof.

15. An OSB according to claim 13, wherein said another material is impregnated in said specialty paper.

16. A method of selectively improving, enhancing and/or modulating one or more particular physical, mechanical and/or chemical properties of an oriented strand board (OSB), said method comprising:
adding one or more types specialty paper demonstrating one or more particular physical, mechanical and/or chemical properties to said OSB during manufacture thereof so as to confer to said OSB said one or more physical, mechanical and/or chemical properties.

17. A method according to claim 16, wherein before said adding step, said method comprises identifying one or more specialty papers demonstrating said one or more particular physical, mechanical and/or chemical properties, said adding step comprising adding said identified one or more specialty papers to said OSB during manufacture thereof.

18. A method according to claim 16, wherein before said adding step, said method comprises manufacturing a specialty paper demonstrating one or more desired particular physical, mechanical and/or chemical properties, said adding step comprising adding said manufactured one or more specialty papers to said OSB during manufacture thereof.

19. A method according to claim 16, further comprising impregnating said specialty paper with another material.

20. A method according to claim 19, wherein before said impregnating step, said method comprises identifying one or more said another material demonstrating one or more desired particular physical, mechanical and/or chemical properties, said impregnating step comprising impregnating said specialty paper with said identified another material, so as to confer said demonstrated particular physical, mechanical and/or chemical properties to said specialty paper, thereby conferring said demonstrated particular physical, mechanical and/or chemical properties to said OSB when adding said specialty paper thereto.

21. A method according to claim 19, wherein said another material is selected from the group consisting of resin, plastic, metal, a synthetic material and any combination thereof.

22. A method according to claim 21, wherein said specialty paper is selected from the group consisting of coated extensible Kraft (grade 486), fireproof aluminium lam paper (grade 5025), multiwall bag (rws) (grade 410) and any combination thereof.
